(19) United States
(12) Patent Application Publication
(10) Pub. No.: US 2007/0237565 A1
(43) Pub. Date: Oct. 11, 2007

(54) REPLICA COSMETIC APPLICATOR

(76) Inventors: Thomas J. Coleman, Abingdon, VA (US); William K. Schlotter, Fredericksburg, VA (US); Princess Ann Coleman, Abingdon, VA (US); Ann M. Schlotter, Fredericksburg, VA (US)

Correspondence Address: CLYDE I. COUGHENOUR, 16607 SUTTON PLACE, WOODBRIDGE, VA, 22191, US

(21) Appl. No.: 11/278,795

(22) Filed: Apr. 5, 2006

(51) Int. Cl. B43K 25/00

(52) U.S. Cl. 401/52

(57) ABSTRACT

A stick dispenser, such as for lip gloss, is housed in a novelty two piece replica. A replica upper piece houses the dispenser cap. A replica lower piece houses the dispenser main body such that the upper extreme of the dispenser extends above the lower replica upper extreme and the turn knob on the lower extreme of the dispenser extends below the lower extreme of the replica lower piece lower extreme. The turn knob feeds the stick up past the dispenser upper extreme so that it can be applied as desired.

### BACKGROUND OF THE INVENTION

1. Field of the Invention

The invention is to a stick applicator housed within a two piece novelty replica.

2. Description of Related Art

It is old to provide applicators where a stick, such as lipstick, lip balm, deodorant, glue, etc., is dispensed at one end of a tube or container by a thread turned at the other end with J. Look, U.S. Design Pat. No. 454,665, issued Mar. 10, 2002, and Estevez et al, U.S. Pat. No. 6,283,658, issued Sep. 4, 2001, examples. Having a cosmetic within a replica is old as shown by Yu-Ching Shih, U.S. Design Pat. No. 483,913, issued Dec. 16, 2003, Yu-Ching Shih, U.S. Design Pat. No. 503,246, issued Mar. 22, 2005. Guegan et al, U.S. Pat. No. 5,454,746, issued Oct. 3, 1995, and Wang et al, U.S. Pat. No. 5,676,583, issued Oct. 14, 1997, and T. Yeh, U.S. Pat. No. 6,059,472, issued May 9, 2000, teach replicas housing different implements or containers.

### SUMMARY OF THE INVENTION

A stick dispenser is housed within a two piece replica that can be in the form of an animate, inanimate or plant form. The bottom knob of the dispenser extends outside the replica lower piece and can support the applicator. The cap of the dispenser is housed within the upper piece of the replica. Removing the cap and upper replica piece exposes the upper end of the dispenser in the lower character piece. By turning the knob at the bottom of the dispenser, a push plate is moved upward by a threaded feed screw. The upper extent of the stick is forced out the upper end of the dispenser for application.

### BRIEF DESCRIPTION OF THE DRAWINGS

FIG. 1 is a front view of a replica housing the dispenser of the invention as stored.

FIG. 2 is a front view of the replica of FIG. 1 with the upper piece of the replica separated from the lower piece of the replica for use.

FIG. 3 is a side view of a second replica, partially in section, showing the dispenser components within the replica.

### DESCRIPTION OF THE PREFERRED EMBODIMENTS

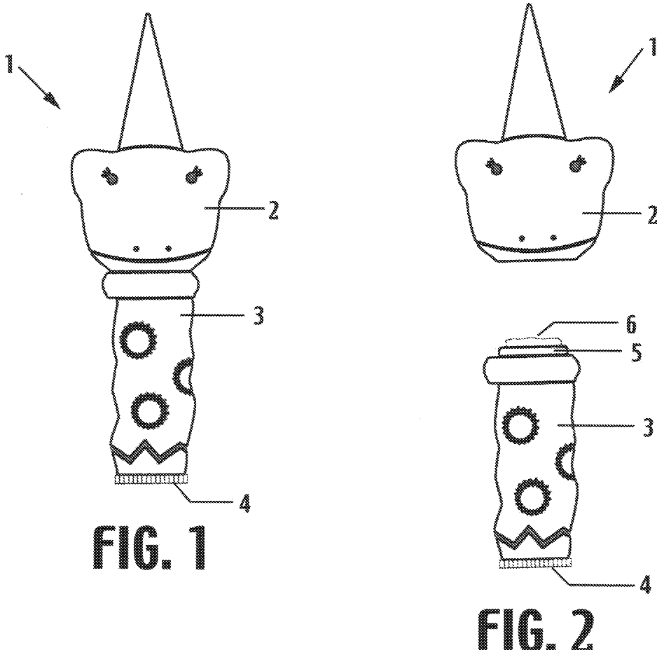

The invention 1 is shown in FIG. 1 as the replica, that can be in the form of any desired real or imaginary animate, inanimate or plant form, appears in its storage configuration. The replica upper body piece is shown as a head 2 on top of a replica lower body piece 3. The only part of the dispenser that is visible is the lower portion knob base 4 that serves as a support for the applicator and as a rotor knob for turning the thread that advances the stick out of the upper end of the dispenser. The stick advancing beyond the dispenser upper end enables application or removal of a portion of the protruding stick when the cap is removed.

The upper piece 2 of the replica 1 is shown separated from the lower piece 3 in FIG. 2. With the upper piece of the replica separated, the upper edge 5 of the dispenser is exposed as well as a portion of the stick 6. In this configuration the stick material can be applied to any desired surface.

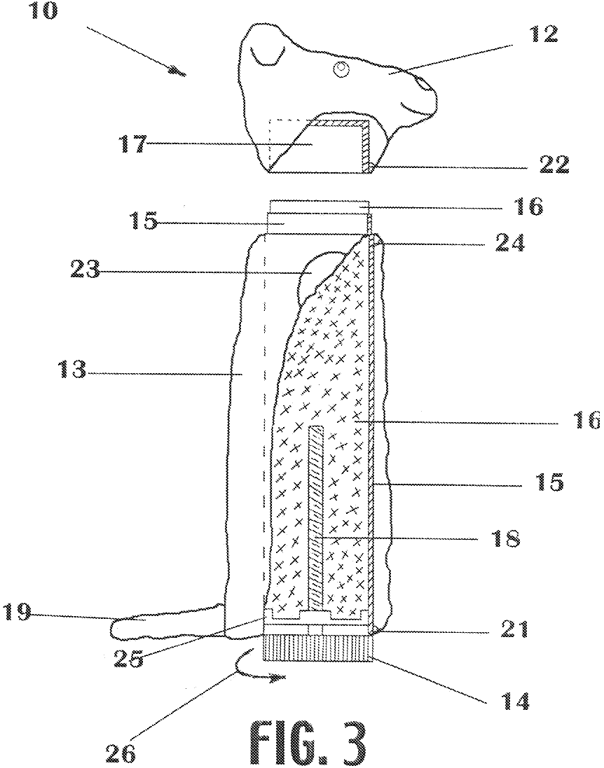

The embodiment depicted in FIG. 3 is of a replica 10 in the general shape of a dog. The head 12 of the replica houses a dispenser cap 17 with the replica upper piece firmly held to the cap by an adhesive 22. The replica lower body piece 13 houses the main dispenser body 15. The lower body piece is firmly held on the dispenser 15 lower end by an adhesive 21 and the lower body piece upper end is firmly held to the dispenser by an adhesive 24. The lower replica piece 13 is shown with a partial front leg 23 and a tail 19. The dispenser upper end 15 protrudes above the replica lower piece 13 upper extent, to accommodate application of the cosmetic stick 16. The dispenser lower end, turn knob 14, protrudes below the replica lower piece 13 lower extent. The knob is turned 26 to feed the stick 16 from the dispenser 15 upper end. The feeding of the stick from the dispenser is accomplished by turning the knob 14 having the feed screw 18 firmly attached to it. The knob outermost surface provides a flat sturdy support for the applicator. The feed screw 18 is attached through a threaded push plate 25. Turning 26 the knob 14 causes the push plate 25 to raise and the stick to advance upward. This is one common stick feed device but other types could be employed.

While the character is shown fixed by adhesive, the character can be molded around a dispenser or attached by any other common joining material.

It is preferred that plush material be used but it could be a foam or plastic or a fabric in the shape of any animate, inanimate, object, or creature.

It is believed that the construction, operation and advantages of this invention will be apparent to those skilled in the art. It is to be understood that the present disclosure is illustrative only and that changes, variations, substitutions, modifications and equivalents will be readily apparent to one skilled in the art and that such may be made without departing from the spirit of the invention as defined by the following claims.

1. A stick applicator comprising:
a dispenser for a stick material;
said dispenser having a cap and a main dispenser body;
a two piece novelty replica having a first upper piece and a second lower piece;
said replica first upper piece housing said dispenser cap;
said replica second lower piece housing said main dispenser body;
said main dispenser body lower extreme extends below said replica second lower piece lower extreme;
said replica first upper piece and said dispenser cap are separable from said replica second lower piece and said main dispenser body to permit coating.

2. A stick applicator as in claim 1 including:
a stick material in said dispenser;
said main dispenser body lower extreme is a knob for adjusting said stick material.

3. A stick applicator as in claim 1 wherein:
said main dispenser body upper extreme extends above said replica second lower piece upper extreme to permit coating.

4. A stick applicator as in claim 2 wherein:
said main dispenser body upper extreme extends above said replica second lower piece upper extreme to permit coating.

5. A stick applicator as in claim 1 wherein:
said dispenser cap and said replica first upper piece are firmly secured together;
said main dispenser body and said replica second lower piece are firmly secured together.

6. A stick applicator as in claim 5 including:
a stick material in said dispenser;
said main dispenser body lower extreme is a knob for adjusting said stick material.

7. A stick applicator as in claim 6 wherein:
said main dispenser body upper extreme extends above said replica second lower piece upper extreme to permit coating.

8. A stick applicator as in claim 2 wherein:
said knob for adjusting said stick material is secured to a feed screw for advancing said stick material.

9. A stick applicator as in claim 8 wherein:
said feed screw extends through a threaded push plate to advance said stick material.

10. A stick applicator as in claim 9 wherein:
said dispenser cap and said replica first upper piece are firmly secured together;
said main dispenser body and said replica second lower piece are firmly secured together.

11. A stick applicator as in claim 1 wherein:
said dispenser cap and said replica first upper piece are molded together;
said main dispenser body and said replica second lower piece are molded together.
